(19) United States
(12) Patent Application Publication
(10) Pub. No.: US 2016/0232799 A1
(43) Pub. Date: Aug. 11, 2016

(54) RECOMMENDATION OF AN ADJUSTMENT TO A LEARNING PLAN OF AN ACADEMIC COURSE

(71) Applicant: Carnegie Learning, Inc., Pittsburgh, PA (US)

(72) Inventors: Sandra Bartle, Jefferson Hills, PA (US); Steve Ritter, Pittsburgh, PA (US); Dave Dengler, Pittsburgh, PA (US); Robert Hausmann, Swissvale, PA (US)

(21) Appl. No.: 14/617,215

(22) Filed: Feb. 9, 2015

(51) Int. Cl. G09B 5/12; G09B 7/00

(52) U.S. Cl. CPC G09B 5/12; G09B 7/00

(57) ABSTRACT

A computer stores a scheduled subset of learning activities. Each learning activity has a duration estimate. The system receives status data indicating a progress of a current learning activity of the scheduled subset. If the status data does not indicate completion of the current learning activity, and the scheduled subset has a sum of duration estimates that exceeds a remaining available teaching time, then the system automatically selects a replacement subset of the learning activities. The replacement subset has a sum of duration estimates that does not exceed the remaining available teaching time. The replacement subset of learning activities is automatically selected by the system based, at least in part, on at least one of: academic standards associated with each of the learning activities; and an importance score associated with each of the learning activities. The system establishes the replacement subset to schedule in place of the scheduled subset.

### FIELD OF THE INVENTION

The present invention relates to academic planning automation based on computerized tracking of teaching progress.

### BACKGROUND

A learning activity is a task that exposes students of an academic course to an academic topic. A learning activity may be a homework assignment, a video presentation, a test or other assessment, a lecture, a laboratory experiment, a classroom project, or other course module that presents an academic topic. Learning activities may be driven by an individual student, a group of students, an entire student body in a classroom, or a teacher.

Multiple learning activities may be available to convey subject matter that is relevant to an academic course. The subject matter of different learning activities may partially or completely overlap. For an academic course, learning activities may be available that are redundant. Redundant learning activities may be substitutes for each other. Thus, for any given student, only one learning activity, from a set of redundant learning activities, needs to be performed.

An academic standard is an essential unit of knowledge from which a broader topic, such as geometry, may be composed. An academic standard may be normative and established by a standards body. Examples of formal standards include a Common Core State Standard, an Iowa Core Standard, and a Texas Essential Knowledge and Skills standard.

Typically, each course has a set of academic standards that students of the course are supposed to master through participation in the course. There is a link between the academic standards that are intended to be covered by the course, and the various learning activities in the course plan. For example, a course that is indented to satisfy standard A and standard B may have an activity 1 that is designed to teach standard A, and an activity 2 that is designed to teach standard B.

An academic course may have more learning activities available than an academic calendar has time to accommodate. A learning plan of an academic course includes learning activities that present the subject matter of the academic course within the time allotted by the academic calendar. Actual progress of a course may depart from the progress that was originally planned. For example, a class may fall behind schedule by one or more learning activities.

### BRIEF DESCRIPTION OF THE DRAWINGS

In the drawings:

FIG. 1 is a block diagram that depicts an example computer for providing an automatic recommendation of an adjustment to a learning plan.

FIG. 2 depicts a flowchart for providing an automatic recommendation of an adjustment to a learning plan.

FIG. 3 is a block diagram that depicts an example computer for providing an automatic recommendation of an adjustment to a learning plan.

FIG. 4 depicts an example screen displayed by an example tablet for providing an automatic recommendation of an adjustment to a learning plan.

FIG. 5 is a block diagram that depicts an example computer for providing an automatic recommendation of an adjustment to a learning plan.

FIG. 6 depicts an example screen displayed by an example tablet for providing an automatic recommendation of an adjustment to a learning plan.

FIG. 7 depicts an example screen displayed by an example tablet for providing an automatic recommendation of an adjustment to a learning plan.

FIG. 8 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A learning plan recommendation system is described hereafter which determines whether there is enough time to complete all of the not-yet-completed learning activities that are identified in the current plan of a course offering. If the system determines that there is not enough time to complete the not-yet-completed learning activities that are identified in the current plan, the learning plan recommendation system automatically proposes a reformulated plan.

In one embodiment, a computer stores data that indicates what learning activities belong to the current plan of a course offering. Each learning activity has a duration estimate. The computer receives status data indicating a progress of a learning activity in the current plan. If the status data does not indicate completion of the current learning activity, and the sum of duration estimates of the not-yet-completed activities in the current plan exceeds the remaining available teaching time of the course offering, then the computer automatically selects a new set of learning activities for the reformulated plan. The new set of learning activities are selected such that the sum of duration estimates of the not-yet-completed learning activities in the reformulated plan does not exceed the remaining available teaching time for the course offering. The set of learning activities for the reformulated plan is automatically selected by the computer based, at least in part, on at least one of: academic standards associated with each of the learning activities; and an importance score associated with each of the learning activities. The computer changes the plan of the course offering to the reformulated plan, to allow the course to finish within the remaining available teaching time.

In another embodiment, each learning activity may have a prerequisite academic standard. A computer receives progress status of many learning activities as they are completed. The computer may also receive a skipped indication that a teacher is abandoning a learning activity. When a current learning activity is completed, the computer selects a next learning activity from the scheduled subset. If the next learning activity has a prerequisite academic standard that was skipped, then the computer selects a review learning activity to familiarize students with the prerequisite academic standard.

In another embodiment, each learning activity of a scheduled subset has a start date. A computer displays the learning activities of the scheduled subset on a timeline, and ordered by start date. On the timeline, the computer may display indicators of the actual and expected progress of the course to visually show how far a class has fallen behind schedule. The computer may display an indicator of a future milestone on the line. On the timeline, the computer may display a tile associated with each learning activity of the scheduled subset. In response to a teacher selecting a tile, the computer may display a detail of the associated learning activity.

### System for Recommending of an Adjustment to a Learning Plan

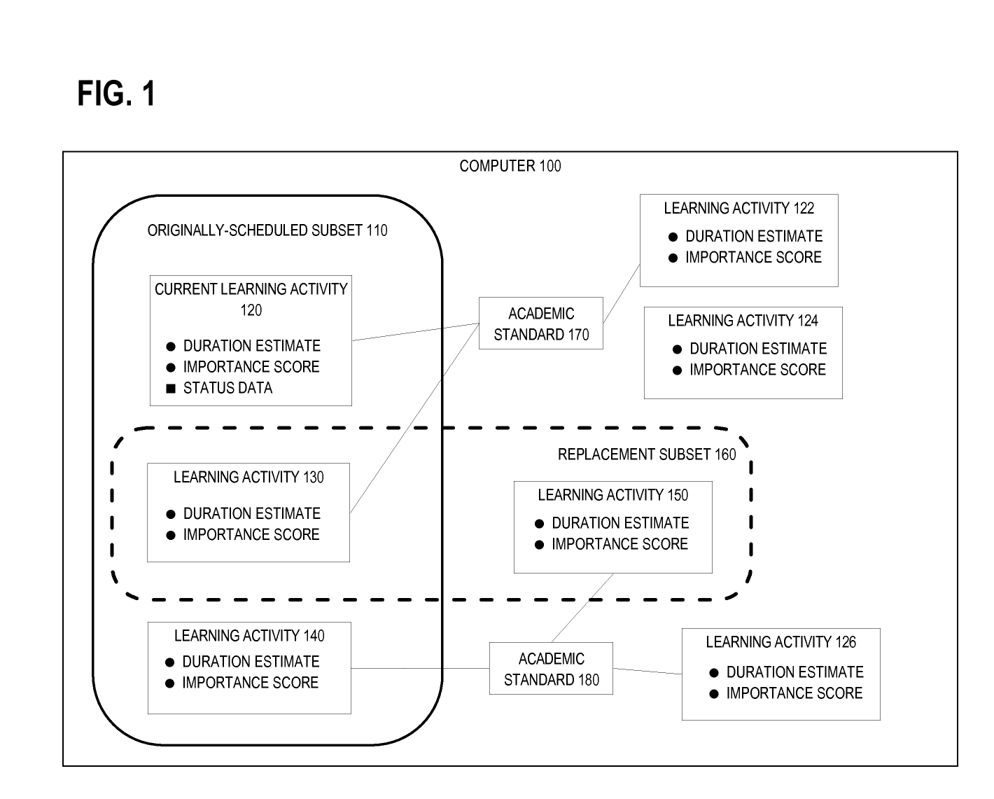

Techniques are described hereafter for automatic recommendation of an adjustment to a learning plan. FIG. 1 is a block diagram that depicts an example computer 100 for providing such an automatic recommendation of an adjustment to a learning plan, according to embodiments. Computer 100 generally represents one or more computing devices, each of which may have any number of processors, volatile memory, and access to persistent storage that may be local or shared.

Computer 100 may be implemented by any type of computing device that is capable of loading, storing, and processing data. Example implementations of computer 100 include, without limitation, rack servers, workstations, personal computers, laptop computers, personal digital assistants (PDAs), tablet computers, cellular telephony devices such as smart phones, and any other type of computing device. As shall be described in greater detail hereafter, computer 100 is configured to manage learning activities, manage learning plans for course offerings, and to automatically recommend adjustments to the learning plans under various circumstances.

### Learning Activities

According to one embodiment, computer 100 stores data about a plurality of learning activities 120, 122, 124, 126, 130, 140 and 150, each of which are available for use in teaching part of a course. Each of learning activities 120, 122, 124, 126, 130, 140 and 150 represents a task that exposes students of an academic course to an academic topic. Learning activities 120, 122, 124, 126, 130, 140 and 150 may each be a homework assignment, a video presentation, a test or other assessment, a lecture, a laboratory experiment, a classroom project, or other course module that presents an academic topic.

Learning activities 120, 122, 124, 126, 130, 140 and 150 may be performed by an individual student, a group of students, an entire student body in a classroom, or a teacher. Many learning activities may be defined to convey subject matter that is relevant to an academic course.

### Learning Plans

The subject matter of different learning activities may partially or completely overlap. For an academic course, learning activities may be available that are redundant. Redundant learning activities may be substitutes for each other, of which only one such learning activity need actually be pursued.

While all of learning activities 120, 122, 124, 126, 130, 140 and 150 are available to teach a course, some of learning activities 120, 122, 124, 126, 130, 140 and 150 are redundant. Further, there simply may not be enough time to teach all of learning activities 120, 122, 124, 126, 130, 140 and 150 in a single course offering. Therefore, for any given course offering, the faculty that is teaching the course offering may design a “learning plan” for the course offering that involves teaching only a subset of the available learning activities. The subset of learning activities that are selected to be in the learning plan of a course offering is referred to herein as the “scheduled subset” of learning activities for the course offering.

For the purpose of explanation, it shall be assumed that a faculty member has selected learning activities 120, 130 and 140 for a particular course offering of the course. Thus, learning activities 120, 130 and 140 are designated as the originally-scheduled subset 110.

Metadata Associated with Learning Activities

According to one embodiment, each of learning activities 120, 122, 124, 126, 130, 140 and 150 is associated with metadata that conveys information about the learning activity. Such metadata may include, for example, information about the academic standards to which the learning activity is linked, as well as an importance score and a duration estimate. Each of these types of metadata shall be described in greater detail hereafter. A curriculum expert may provide metadata during creation of learning activities.

### Academic Standards Metadata

Referring again to FIG. 1, it illustrates the links between learning activities and academic standards. Specifically, learning activities 120, 122 and 130 are linked to academic standard 170, and learning activities 126, 140 and 150 are linked to academic standard 180. As shall be described in greater detail hereafter, when generating learning plan recommendations, computer 100 may be configured select learning activities to include in the learning plan of a course offering in a manner that maximizes the amount of academic standards covered by the scheduled subset of the course offering.

### Importance Score Metadata

According to one embodiment, the metadata of each learning activity also includes an importance score. An importance score of a learning activity indicates a relative priority that computer 100 may give to the learning activity when deciding whether or not to include the learning activity in originally-scheduled subset 110. An importance score may be a number, a letter, a color, or any other rank that indicates a level of importance of a learning activity relative to other learning activities. A learning activity that addresses mandatory subject matter may have a high importance score. A learning activity that addresses optional subject matter may have a low importance score. A lesson intended as a primary learning activity of a subject matter may have a high importance score. A class project intended as secondary learning activity of the same subject matter may have a low importance score. When selecting learning activities for inclusion in originally-scheduled subset 110, computer 100 may be configured to maximize the sum of importance scores within originally-scheduled subset 110. However computer 100 may be configured to maximize coverage of academic standards over generally maximizing importance scores. Computer 100 may also be configured to process importance scores when replacing originally-scheduled subset 110, as when a learning plan needs adjustment.

### Duration Estimate Metadata

According to one embodiment, the metadata of each learning activity also includes a duration estimate. A duration estimate is an expected amount of time needed to perform a learning activity. The duration estimate is the amount of time computer 100 may allocate in a learning plan to include the learning activity. The duration estimate may use general purpose units such as hours or days or may use abstract units such as class sessions.

### Metadata Axes

According to one embodiment, each type of metadata represents a scoring dimension. Multiple types of metadata present multiple dimensional axes. Before a course is offered, a curriculum expert may assign a relative score to each learning activity along each of the metadata axes. For example if there are three metadata types, such as duration estimate, importance score, and student aptitude, then each learning activity may be scored along three metadata axes. Three axes define a cube, and metadata scores assigned to a learning activity define the position of the learning activity within the cube. A curriculum expert may design redundant learning activities that teach the same academic standard but vary in position along the metadata axes. The more variety of positions in the cube occupied by redundant learning activities, the more flexibility computer 100 has when reformulating a learning plan by substituting one redundant learning activity for another.

### Need for Learning Plan Adjustments

Based on duration estimates, computer 100 may select learning activities for originally-scheduled subset 110 that fill the available time of an academic calendar of a course. Computer 100 is configured to avoid overbooking originally-scheduled subset 110 with learning activities having combined duration estimates that exceed the available time of the academic calendar.

However, many factors may cause the actual amount of time taken for a class to perform a learning activity to deviate from the duration estimate of the activity. Factors such as general teacher experience, teacher familiarity with subject matter, teacher familiarity with activity structure, student body aptitude, student family support, interruptions, or other circumstantial issues may cause a learning activity to complete in more or less time than estimated.

At times computer 100 may detect that an actual progress of a course has departed from a progress that was originally planned. For example a class may fall behind schedule by one or more learning activities. If a class has fallen behind, computer 100 may devise a new learning plan having a time feasible schedule. If a class becomes ahead of schedule, computer 100 may devise a more involved learning plan. In either case, it is unlikely that originally-scheduled subset 110 remains optimal, or even feasible, for the course offering. To better fit the new learning plan, computer 100 selects replacement subset 160 of learning activities as a replacement for originally-scheduled subset 110.

When reformulating a learning plan, computer 100 may store an academic calendar of limited duration and many more, likely redundant, learning activities than can fit within the available teaching time. There may be surplus learning activities that are not scheduled, despite being relevant to a learning plan.

The learning activities of replacement subset 160 and originally-scheduled subset 110 may partially overlap. For example learning activity 130 is included in both of originally-scheduled subset 110 and replacement subset 160. If computer 100 re-plans because a class has fallen behind, some learning activities that are included in originally-scheduled subset 110 may be excluded from replacement subset 160. Lengthy learning activities of originally-scheduled subset 110 may be replaced by shorter learning activities having smaller duration estimates. When selecting the learning activities to include in replacement subset 160, computer 100 may be configured to maximize which academic standards are covered by the replacement subset. For example learning activity 140 of originally-scheduled subset 110 is replaced by learning activity 150 of replacement subset 160. Both of these replacement and replaced learning activities are linked to academic standard 180.

Although only learning activities 130 and 150 are shown in replacement subset 160, other learning activities may be included in replacement subset 160. Although only academic standards 170 and 180 are shown in FIG. 1, computer 100 may have additional academic standards that are considered during planning. Originally-scheduled subset 110, replacement subset 160, their learning activities, and their academic standards are structures stored within computer 100. Any of these structures may reside within the memory or durable storage of computer 100. Computer 100 may include a file system or database to organize these structures. Computer 100 may contain more learning activities and academic standards than are shown.

### Process Overview

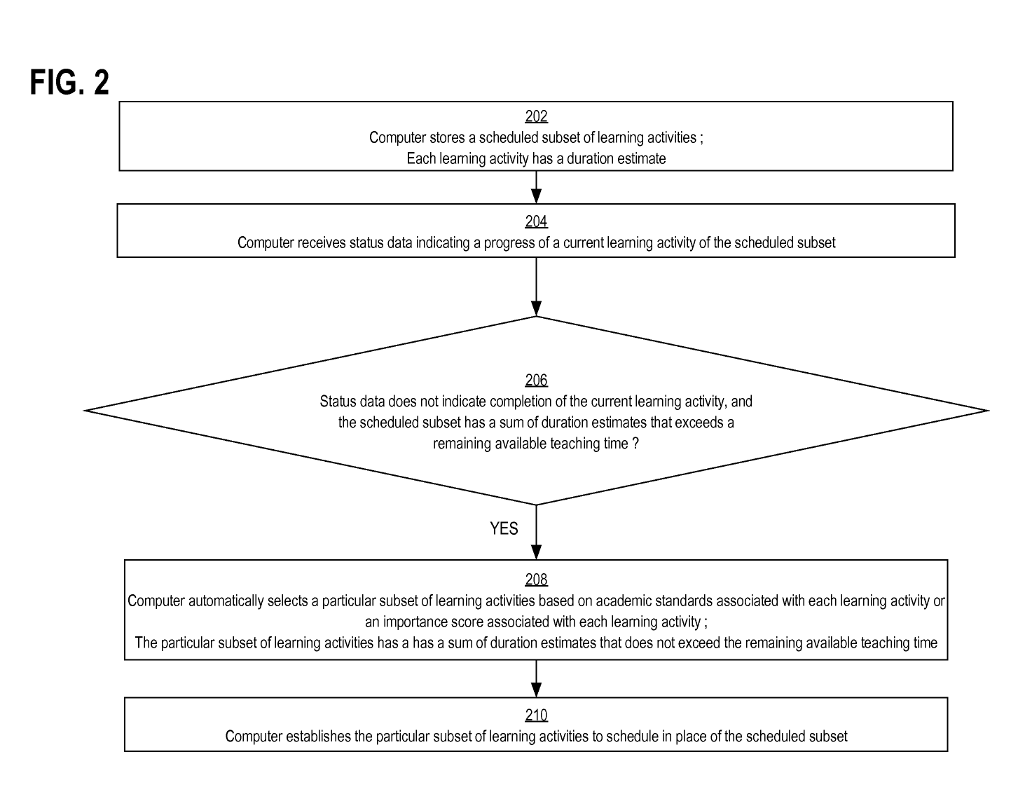

FIG. 2 illustrates a process for automatic recommendation of an adjustment to a learning plan, in an example embodiment. For purposes of illustrating a clear example, FIG. 2 may be described with reference to FIG. 1, but using the particular arrangements illustrated in FIG. 1 is not required in other embodiments.

In step 202 a computer stores an existing learning plan of an academic course. For example, computer 100 stores originally-scheduled subset 110 of learning activities. Learning activities and originally-scheduled subset 110 may be stored as records in a file or a database table. Each learning activity of originally-scheduled subset 110 has a duration estimate. The learning activities for the originally-scheduled subset 110 have been selected such that the sum of duration estimates of the learning activities in the originally-scheduled subset 110 does not exceed the time available in an academic calendar for the course.

In step 204, the computer receives status data indicating how students in a particular course offering are progressing on the learning activity that the students are currently working on. The activity that students of a course offering are currently working on is referred to herein as “the current learning activity” of the course offering. For example, a teacher may inform computer 100 that current learning activity 120 has completed or that the allotted time for current learning activity 120 is exhausted. Computer 100 may receive status data at the beginning of a class session, at the end of a class session, or at another time. Alternatively, the computer proactively determines the status of a class offering on a periodic basis, such as daily or weekly. Each periodic check of a given course offering may determine, among other things, which learning activity the students are currently working on, and the learning activities that have not yet been completed.

In step 206 the computer assesses the progress of the class and decides the suitability of the learning plan. For example, at an end of a time allotted for current learning activity 120, a teacher may inform computer 100 that current learning activity 120 is incomplete. Computer 100 may decide that the class has fallen behind schedule. Computer 100 may decide that the learning plan has become infeasible based on a sum of duration estimates of the not-yet-completed activities in the originally-scheduled subset 110 exceeding a remaining available time on the academic calendar of the course. If status data indicates that current learning activity 120 is incomplete, and computer 100 determines that the learning plan is time infeasible, then computer 100 may decide to reformulate the learning plan.

In step 208 the computer formulates a new learning plan to replace an infeasible plan. For example computer 100 may select replacement subset 160 of learning activities to accomplish a new learning plan that replaces originally-scheduled subset 110 and the infeasible learning plan. Computer 100 may base the selection of learning activities for inclusion in replacement subset 160 on factors to achieve a suitable learning plan. Computer 100 may use heuristics for selecting learning activities to achieve an optimal learning plan. Computer 100 may process an importance score or an associated academic standard of each available learning activity when deciding which learning activities to include in replacement subset 160. Inclusion of learning activities within replacement subset 160 may be limited according to available teaching time remaining in the academic calendar of the course. Computer 100 selects replacement subset 160 of learning activities that have a sum of duration estimates that does not exceed the remaining available teaching time.

In step 210, the computer replaces the infeasible learning plan with the new plan. For example computer 100 may establish replacement subset 160 in place of originally-scheduled subset 110 to implement a reformulated learning plan. In one embodiment, the replacement is made by the computer automatically.

In an alternative embodiment, the replacement is only made upon express approval of a human. For example, replacement of one learning plan with another may need teacher approval and perhaps other teacher input. Rejection of replacement subset 160 by a teacher may prevent replacement subset 160 from replacing originally-scheduled subset 110.

In an embodiment where human approval is required, computer 100 may display a summary of replacement subset 160. The summary may include a summary of differences between originally-scheduled subset 110 and replacement subset 160, an amount of time saved by establishing replacement subset 160 in place of originally-scheduled subset 110, or other details. The interface displayed by the computer may include a control that enables the faculty that is teaching the relevant course offering to approve or decline the recommended adjustment to the learning plan of the course offering. In response to acceptance of the recommended adjustment, computer 100 may update a file or a database to store data that indicates the course offering will now use the replacement subset 160.

While an embodiment has been described in which a single adjustment recommendation is determined, in alternative embodiments, the computer may generate any number of alternative adjustment recommendations. Summaries of each alternative adjustment recommendation may be presented to the user, along with a control that allows the user to select which of the alternative adjustment recommendations to adopt, if any, for the course offering in question.

History Based Pacing with Learning Activities of Varied Intensity

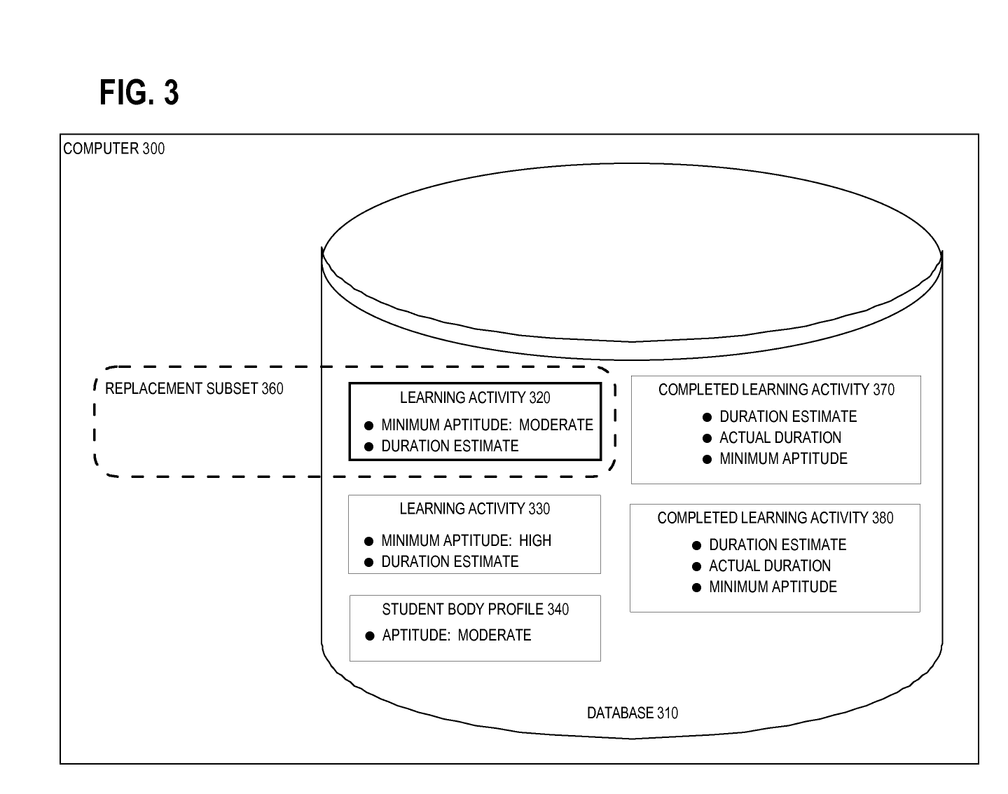

FIG. 3 is a block diagram that depicts an example computer 300 for providing an automatic recommendation of an adjustment to a learning plan of a course offering (the “target course offering”) based on historical performance and intensity of learning activities, according to embodiments. Computer 300 may be an implementation of computer 100 and may have any of the form factors of computer 100, although computer 100 may have other implementations. Computer 300 has access to durable storage that stores a database 310. Database 310 may be a relational database management system or other facility that stores and manages data. For the target course offering, computer 300 and database 310 maintain a learning plan, a scheduled subset of learning activities, and a history of completed learning activities for the particular course offering.

Database 310 includes metadata for learning activity 320, learning activity 330, completed learning activities 370 and 380, and student body profile 340. Completed learning activities 370 and 380 are learning activities that have been completed in the target course offering, and are therefore no longer included within the scheduled subset because their performance is done. Information about completed learning activities 370 and 380 is stored within database 310 to provide historical data of an aggregate performance of the student body of the target course offering. The metadata associated with completed learning activities 370 and 380 includes a duration estimate, a minimum aptitude, and an actual duration. An actual duration is an amount of time that a learning activity consumed during its performance.

Student body profile 340 represents data that indicates aptitude, as an assessment of the collective proficiency of students of the target course offering. Computer 300 may use that aptitude information as a factor for selecting learning activities if the learning plan for the target class offering needs to be adjusted. Aptitude may be represented as a number, a letter, a color, or any other rank that indicates a level of ability and predictor of productivity within the course. In addition to or instead of automatically determining the aptitude of students in the target course offering based on test scores, a teacher may initially enter and later adjust the aptitude rating of the students enrolled in the target course offering. During automatic reformulation of the learning plan of the target course offering, computer 300 selects replacement subset 360 to replace a scheduled subset of learning activities.

Computer 300 may configure replacement subset 360 as a variation of the currently scheduled subset, perhaps by replacing a learning activity of the scheduled subset with a substitute learning activity. When selecting a substitute learning activity, computer 300 may process the aptitude of student body profile 340 to select a learning activity that best matches the ability level of the students of the course. For example learning activities 320 and 330 may include the same subject matter. However learning activities 330 and 340 may not be intended for the same student body. Each of learning activities 320 and 330 has a minimum aptitude that a student body should have in order to complete the learning activity within the duration estimate of the learning activity. In this example student body profile 340 has a moderate aptitude. Although learning activities 320 and 330 address the same subject matter, computer 300 selects learning activity 320 for inclusion in replacement subset 360 because learning activity 320 has a minimum aptitude that does not exceed the aptitude of student body profile 340. Database 310 and replacement subset 360 may contain more learning activities than are shown.

As time advances, computer 300 receives status data that indicate the completion of other learning activities, such as completed learning activities 370 and 380 and perhaps others not shown. Computer 300 records within each of completed learning activities 370 and 380 a minimum aptitude, a duration estimate, and an actual duration. An actual duration is an amount of time that elapsed during the performance of a learning task. Computer 300 may process estimated and actual durations and minimum aptitudes of completed learning activities to automatically determine the aptitude of student body profile 340. For example computer 300 may determine that student body profile 340 has a high aptitude if the students have finished several learning activities of moderate minimum aptitude in significantly less than the estimated durations of those learning activities. By keeping the aptitude of student body profile 340 manually or automatically accurate, computer 300 may select learning activities of a more suitable intensity for a given student body when reformulating a learning plan.

Computer 300 may be configured to perform additional processing in response to an adjustment to the aptitude of student body profile 340. For example, a more apt student body may need less time to finish future learning activities. If the aptitude of student body profile is increased, then computer 300 may reduce the duration estimates of learning activities that have not been completed, such as learning activities 320 and 330. Conversely if the aptitude of student body profile is decreased, then computer 300 may increase the duration estimates of learning activities that have not been completed. Because an adjustment to the aptitude of student body profile 340 may potentially affect duration estimates of many unfinished learning activities and have a large impact on learning plan reformulation, computer 300 may be configured to solicit or automatically determine an updated aptitude of student body profile 340 frequently during an early portion of an academic course.

### Teacher Decisions and Short Term Planning

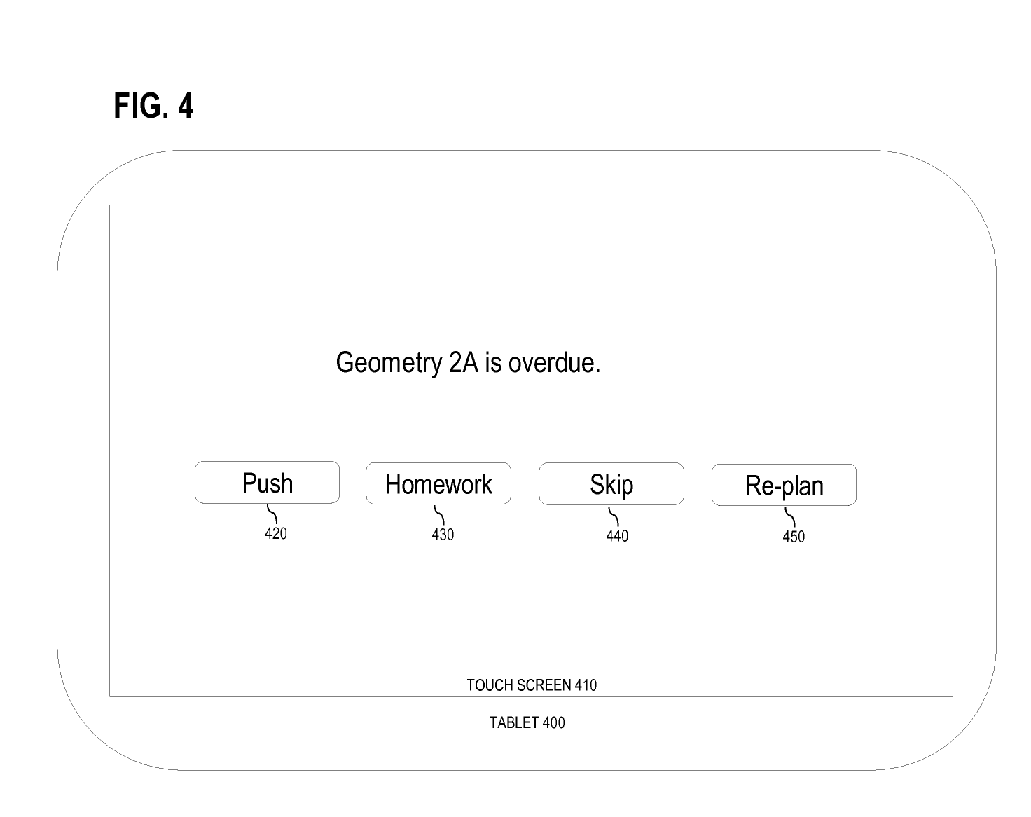

FIG. 4 depicts a screen displayed on example tablet 400 that offers a teacher choices for handling a current learning activity that is overdue, according to embodiments. Tablet 400 may be an implementation of computer 100 or 300 and may have any of the form factors of computer 100 or 300, although computers 100 and 300 may have other implementations. Tablet 400 includes touch screen 410 that operates as a display screen and a pointer input device. Touch screen 410 may instead comprise a display screen and a pointer input device as separate components, such as an external monitor and a mouse or stylus.

Tablet 400 may detect that an academic course has fallen behind schedule. In this example, tablet 400 has assigned a due date to each learning activity of a scheduled subset. The due date is a time when a learning activity is expected to be finished according to a schedule. In this example, tablet 400 has determined that a learning activity, perhaps the current learning activity, is unfinished, and that the due date of the learning activity has elapsed. Tablet 400 uses touch screen 410 to alert a teacher that the learning activity is overdue. An alert may be in response to the teacher entering status data into tablet 400. An alert may offer the teacher alternative ways to handle the overdue learning activity. For example, touch screen 410 displays controls 420, 430, 440, and 450 that correspond to choices for the teacher to select to direct tablet 400 on how to handle the overdue learning activity. Controls 420, 430, 440, and 450 may be push buttons, hyperlinks, menu items, or other interactive controls that detect and react to user selection.

The teacher may decide to continue performing the unfinished learning activity, perhaps by deferring a portion of the unfinished learning activity into the next class session. By pressing push control 420, the teacher may inform tablet 400 that the unfinished learning activity should remain ongoing, and that the scheduled subset of learning activities should not be disturbed. By pressing homework control 430, the teacher may inform tablet 400 that a homework learning activity that corresponds to the unfinished learning activity should be scheduled in place of the unfinished learning activity. Tablet 400 may set the due date of the homework learning activity to be the beginning of the next class session.

By pressing skip control 440, the teacher may inform tablet 400 that the unfinished learning activity is being abandoned. This may cause tablet 400 to remove the unfinished learning activity from the scheduled subset. Perhaps based on proximity of due date, tablet 400 may select another learning activity of the scheduled subset to become the current learning activity. Tablet 400 may record the disposition of learning activities that were performed earlier in a course. Tablet 400 may record which learning activities have been skipped and which ones have been completed.

A teacher may suspect that too many learning activities have been skipped, or that a class has fallen too far behind schedule. For whatever reason and at any time, a teacher may decide that a new learning plan is necessary. By pressing re-plan 450, the teacher may inform tablet 400 that a learning plan should be reformulated and the scheduled subset of learning activities be adjusted accordingly. Tablet 400 may offer other ways for a teacher to trigger re-planning.

### Prerequisite Academic Standards of Learning Activities

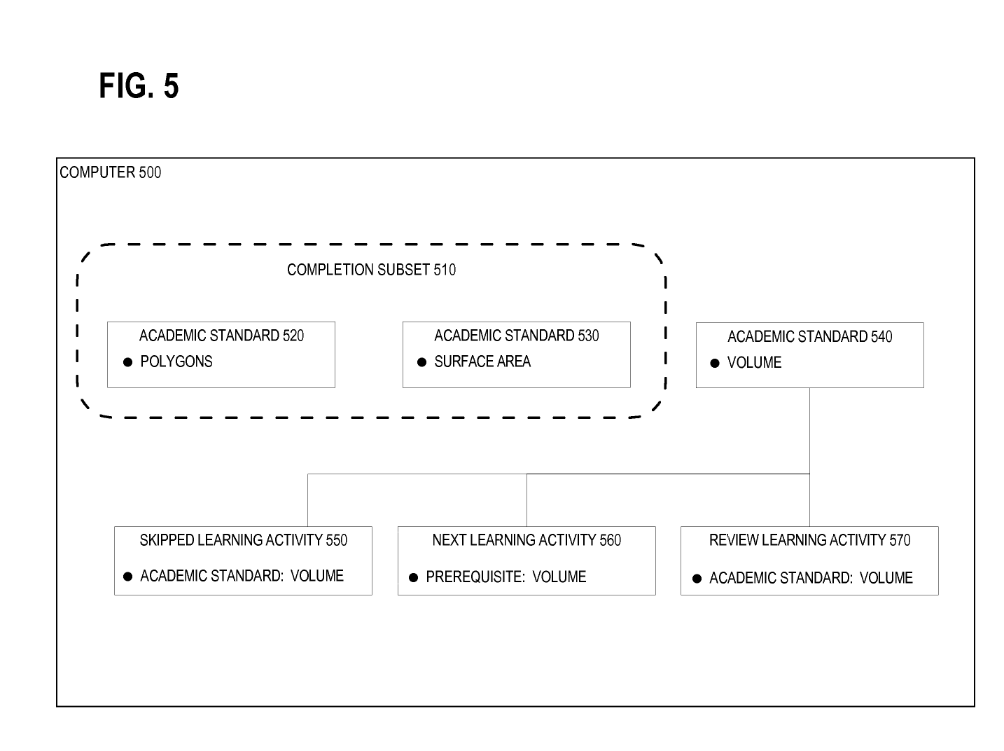

FIG. 5 depicts example computer 500 that processes prerequisite academic standards of learning activities, according to embodiments. Computer 500 may be an implementation of computer 100 or 300 or tablet 400 and may have any of the form factors of computer 100 or 300 or tablet 400, although computers 100 and 300 and tablet 400 may have other implementations. Computer 500 stores completion subset 510, academic standards 520, 530, and 540, skipped learning activity 550, next learning activity 560, and review learning activity 570. Computer 500 may store additional academic standards and learning activities.

A learning plan may include a progression of learning activities that are linked to academic standards that build on each other. A learning activity may have prerequisite standards (standards that should be mastered by a user before the user engages in the learning activity) and prerequisite learning activities (other activities that a user should performed before the user performs the learning activity). When formulating a learning plan and selecting a scheduled subset of learning activities, computer 500 may process prerequisites as dependencies between learning activities.

As time progresses, students complete learning activities in their course offering. Those completed learning activities are linked to academic standards. Academic standards that are linked to a completed learning activity is referred to herein as a “completed academic standard”. According to one embodiment, computer 500 tracks which standards have been completed by the students in a course offering. For example, completion subset 510 identifies a set of completed academic standards (academic standards 520 and 530) that were covered by learning activities that have been completed. Completion subset 510 may contain other academic standards that have been covered and may also contain learning activities that have been completed. In this example a current learning activity may finish, and computer 500 may select a next learning activity 560 to become the new current learning activity according to the learning plan. However, some earlier learning activities may have been skipped to prevent a class from falling far behind schedule. In the example illustrated in FIG. 5, learning activity 550 has been skipped.

A consequence of abandoning skipped learning activity 550 may be that next learning activity 560 may linked to a prerequisite academic standard that was not covered, such as academic standard 540. For example, computer 500 may detect that next learning activity 560 has standard 540 as a prerequisite academic activity. Since activity 560 was skipped, academic standard 540 is not in completion subset 510. Computer 500 may recommend adjusting the learning plan of the target course offering to include a brief overview learning activity that is linked to standard 540 to quickly present the academic standard 540 that was not covered but should have been. For example, computer 500 may recommend a learning plan adjustment that establishes review learning activity 570 as a current learning activity, because review learning activity 570 and skipped learning activity 550 both cover academic standard 540, and review learning activity 570 has a duration estimate that is less than a duration estimate of skipped learning activity 550.

Visual Timeline of a Learning Plan and Drilling Down into a Learning Activity

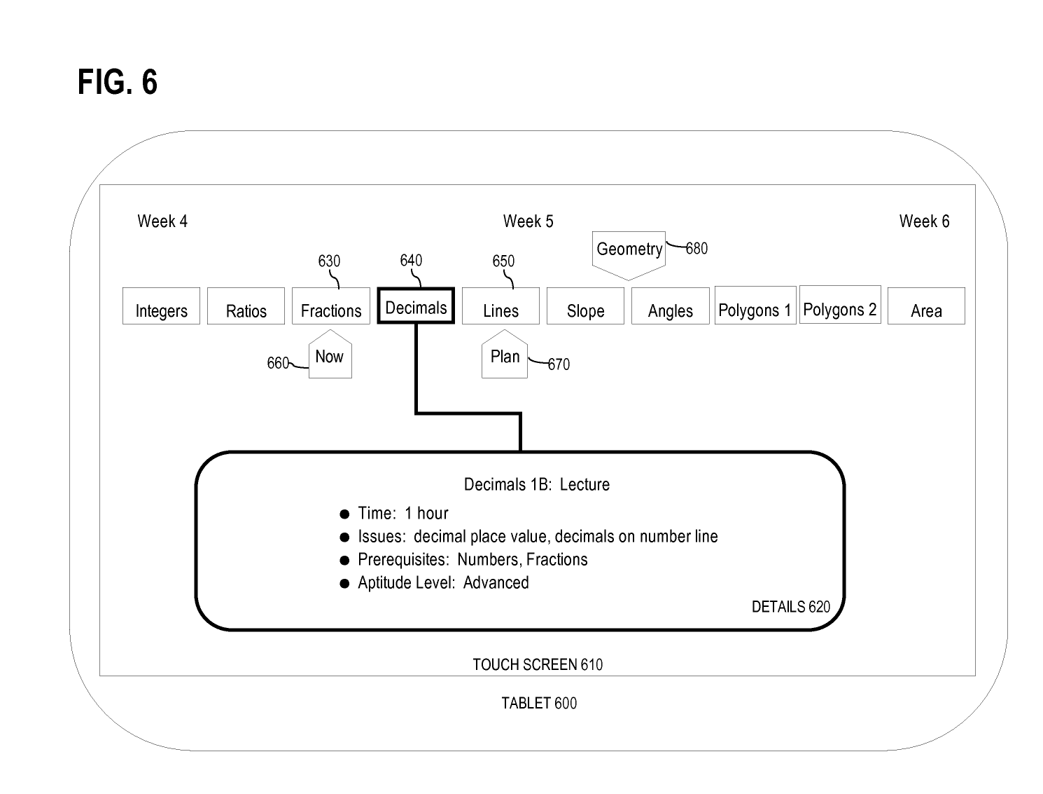

FIG. 6 depicts example tablet 600 that places learning activities of a learning plan along a timeline arranged by start date, according to embodiments. Tablet 600 may be an implementation of tablet 400 or computer 100, 300, or 500 and may have any of the form factors of tablet 400 or computer 100, 300, or 500, although tablet 400 and computers 100, 300, and 500 may have other implementations. Tablet 600 includes touch screen 610. Touch screen 610 may be an implementation of touch screen 410, although touch screen 410 may have other implementations.

Each learning activity of a scheduled subset for a learning plan may have a start date, which is when a learning activity is scheduled to be performed. Tablet 600 may display on touch screen 610 a timeline that shows a sequence of learning activities included in the scheduled subset ordered from left to right by start date. For example, touch screen 610 displays learning activities 630, 640, and 650 and other learning activities in a horizontal row. A timeline that has too many learning activities to fit on touch screen 610 may be wrapped to fit or interactively scrolled by scrollbar or dragging. Touch screen 610 may display the timeline in response to a teacher submitting status data to tablet 600.

The timeline may include markers 660, 670, and 680 that indicate noteworthy points. For example, plan 670 indicates learning activity 650 as how far a class would be along a learning plan if progress had occurred according to the learning plan. However in this example the class is behind schedule by two learning activities. Now 660 indicates that the current learning activity is learning activity 630. Markers 660 and 670 may be interactively selectable. Tablet 600 may offer to reformulate the learning plan if either of markers 660 or 670 is pressed. In addition to expected and actual progress, touch screen 610 may also display important milestones along the timeline of the learning plan. For example, geometry 680 indicates that the academic course will soon transition into learning activities for another major topic.

Each learning activity displayed along the timeline may be an interactively selectable control, such as a push button or a hyperlink. Interactive selection may occur by pressing, as with a mouse click, or by hovering, as with a pointer cursor. A learning activity control may react differently depending on whether selection is by pressing or hovering. An implementation that includes a mouse may react differently depending on whether a click was performed with a left button or a right button. For example, pressing a learning activity control may cause a context menu to appear with choices that help a teacher to enter status or skip a learning activity. In this example, learning activity 640 is interactively selected, perhaps by hovering of a mouse cursor. In response to the interactive selection, touch screen 610 displays details 620 that reveal information about learning activity 640.

### Visual Comparison of Alternative Learning Plans

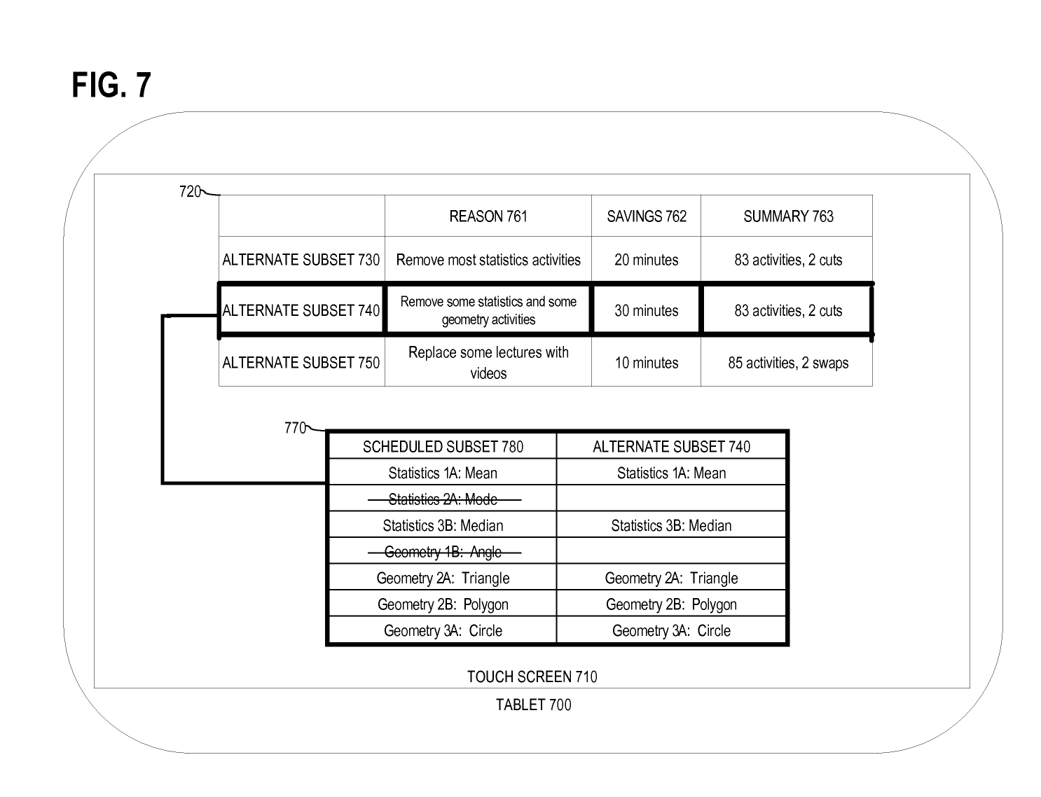

FIG. 7 depicts example tablet 700 that visually compares learning plans, according to embodiments. Tablet 700 may be an implementation of tablets 400 or 600 or computer 100, 300, or 500 and may have any of the form factors of tablet 400 or 600 or computer 100, 300, or 500, although tablets 400 and 600 and computers 100, 300, and 500 may have other implementations. Tablet 700 includes touch screen 710. Touch screen 710 may be an implementation of touch screen 410 or 610, although touch screens 410 and 610 may have other implementations.

When reformulating a learning plan, tablet 700 may store an academic calendar of limited duration and many more, likely redundant, learning activities than can fit within the available teaching time. Because of these surplus learning activities, the combinatorics involved with selecting learning activities for inclusion in a scheduled subset may allow for an overwhelming range of different learning plans. Although many learning plans may be time feasible and fully cover academic standards, not all learning plans are equally suitable.

During reformulation of a learning plan and to some extent, tablet 700 may be configured optimize a learning plan based on importance scores of learning activities or the aptitude of a student body. However, selection of a best plan may involve input from a teacher, who can bring more sensitivities, insights, and familiarity with the student body to the process of plan reformulation. As such and when an existing learning plan becomes time infeasible, tablet 700 may be configured to generate and offer alternative learning plans from which the teacher may choose the best plan to adopt.

During plan reformulation, tablet 700 may generate alternate subsets 730, 740, and 750 of learning activities to replace scheduled subset 780 that has become time infeasible. Alternate subsets 730, 740, and 750 are generated with learning activities having combined duration estimates that do not exceed the available time of the academic calendar. Touch screen 710 may display alternate subsets 730, 740, and 750, perhaps in a structured format such as alternatives table 720. Each row of alternatives table 720 displays information about one alternate subset. Alternatives table 720 may have columns that summarize the differences between alternate subsets 730, 740, and 750.

For example, each cell of reason column 761 displays a general explanation of how an alternate subset diverges from scheduled subset 780. Each cell of reason column 761 may alert the teacher about a character of an alternate subset that the teacher may quickly recognize as suitable or unsuitable. Each cell of reason column 761 may mention an academic standard, or a broader general topic consisting of multiple academic standards, that is impacted or otherwise adjusted in an alternate subset. Each cell of savings column 762 displays how much faster, in terms of combined duration estimates of included learning activities, would be performance of an alternate plan than the scheduled plan. Each cell of summary column 763 displays tallies of how many learning activities an alternate subset has and how many learning activities were removed, added, or substituted.

Each cell of alternatives table 720 may be a control that responds to interactive selection such as a press or hover. Each cell of a row may react in the same or different ways. A hover, left click, or right click may cause the same or different reactions. One reaction that the teacher may trigger is a selection of an alternate subset as the replacement subset to establish in place of scheduled subset 780. Another reaction that the teacher may trigger is a drilling down into the details of an alternate subset.

In this example, pressing any cell initiates drilling down into the details of an alternate subset for a row that contains that cell. For example, when the teacher presses the row for alternate subset 740, touch screen 710 reacts by showing comparison table 770. Comparison table 770 displays two columns. A left column displays the details of scheduled subset 780 for the existing learning plan. A right column shows the details of whichever alternate subset was interactively drilled down into. The left and right columns of comparison table 770 provide a side by side comparison of precisely how alternate subset 740 differs from scheduled subset 780.

Each row of comparison table 770 displays a learning activity. If comparison table 770 has too many rows to display, comparison table 770 may interactively scroll by scrollbar or dragging. Scheduled subset 780 and alternate subset 740 mostly have the same learning activities, as shown in comparison table 770. Because plan reformulation usually occurs when a learning plan has become time infeasible, a learning activity in scheduled subset 780 might not be in alternate subset 740, because the learning activity was removed to save time. Comparison table 770 may display a removed learning activity with lettering crossed out in the left column and the right column left blank. If time is saved by substituting a short learning activity for a long learning activity, then the long one may appear in the left column, and the short one may appear in the right column. Comparison table 770 may use decoration such as cell color or font color to better highlight differences between two subsets being compared.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

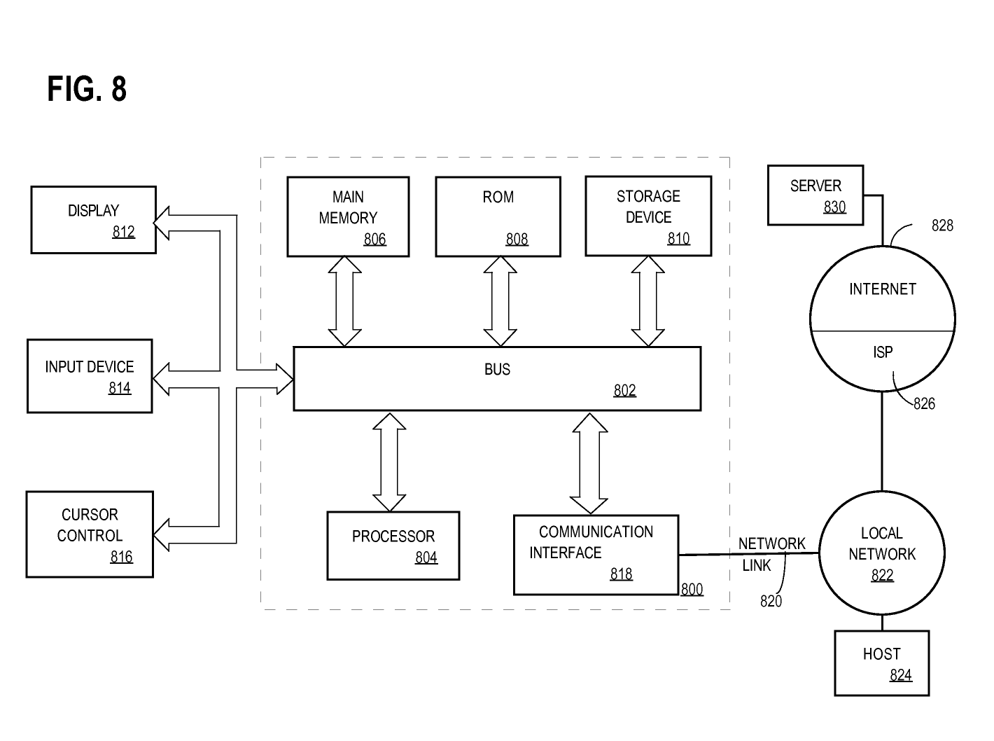

For example, FIG. 8 is a block diagram that illustrates a computer system 800 upon which an embodiment of the invention may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or solid-state drive is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 810. Volatile media includes dynamic memory, such as main memory 806. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method for automatically recommending an adjustment to a learning plan of a course offering, the method comprising:
storing, by a system that includes one or more computing devices, metadata for a plurality of learning activities;
wherein the metadata includes, for each learning activity of the plurality of learning activities, a duration estimate;
storing, by the system, data that identifies which learning activities, of the plurality of learning activities, belong to a scheduled subset for said course offering;
wherein the scheduled subset includes learning activities that are in the learning plan of the course offering, but have not yet been completed within the course offering;
the system obtaining progress information that indicates progress of the course offering;
based on the progress information and the duration estimates of the learning activities in the scheduled subset, the system determining whether the course offering will finish within a remaining available teaching time;
responsive to determining that the course offering will not finish within the remaining available teaching time, the system performing the steps of:
automatically selecting a replacement subset of the plurality of learning activities;
wherein the replacement subset of the plurality of learning activities has a sum of duration estimates that does not exceed the remaining available teaching time;
wherein the replacement subset of learning activities is automatically selected by the system based, at least in part, on at least one of:
one or more academic standards associated with each of the plurality of learning activities;
an importance score associated with each of the plurality of learning activities; or
one or more aptitude scores associated with each of the plurality of learning activities;
establishing the replacement subset of the plurality of learning activities to schedule in place of the scheduled subset.

2. The method of claim 1 wherein the replacement subset is selected based, at least in part, on the one or more academic standards associated with each of the plurality of learning activities.

3. The method of claim 1 wherein the replacement subset is selected based, at least in part, on the importance score associated with each of the plurality of learning activities.

4. The method of claim 1 wherein the replacement subset is selected based, at least in part, on one or more aptitude scores associated with each of the plurality of learning activities.

5. The method of claim 4 wherein the system selects the replacement subset based, at least in part, on a comparison of an aptitude level of students in the course offering and the one or more aptitude scores.

6. The method of claim 5 wherein the system determines the aptitude level automatically based on at least one of:
how much time students in the course offering took to perform already-completed learning activities; or
how well students in the course offering performed on one or more assessments.

7. The method of claim 6 further comprising the system adjusting duration estimates of learning activities based on the aptitude level.

8. The method of claim 1 wherein the replacement subset is selected based, at least in part, on both the one or more academic standards associated with each of the plurality of learning activities and the importance score associated with each of the plurality of learning activities.

9. The method of claim 1 further comprising:
the system displaying a summary of the replacement subset;
in response to the system receiving an indication that a teacher accepts the replacement subset, the system automatically establishing the replacement subset of the plurality of learning activities to schedule in place of the scheduled subset.

10. The computer-implemented method of claim 9 wherein:
selecting a replacement subset comprises the system selecting a plurality of alternate subsets of the plurality of learning activities, each alternate subset has a sum of duration estimates that does not exceed the remaining available teaching time;
displaying a summary comprises the system displaying a summary of each alternate subset of the alternate subsets;
the indication that a teacher accepts comprises an indication that the teacher accepts an acceptable subset of the alternate subsets;
establishing the replacement subset comprises establishing the acceptable subset to schedule in place of the scheduled subset.

11. The computer-implemented method of claim 9 wherein displaying a summary of each alternate subset comprises the system displaying a numeric difference between the sum of duration estimates of the scheduled subset and the sum of duration estimates of each alternate subset.

12. The computer-implemented method of claim 9 wherein:
the academic standard of each learning activity is associated with a general topic;
each alternate subset has a sum of duration estimates comprises the scheduled subset and each alternate subset has multiple covered general topics, and each covered general topic has a sum of duration estimates of learning activities of the scheduled subset or each alternate subset;
displaying a summary of each alternate subset comprises the system displaying a covered general topic of each alternate subset having a sum of duration estimates that is less than the sum of duration estimates of the scheduled subset with the covered general topic.

13. The computer-implemented method of claim 1 wherein selecting a replacement subset comprises:
the system selecting a substitute learning activity from the learning activities having a same academic standard as a learning activity of the scheduled subset;
the system including the substitute learning activity in the replacement subset.

14. The computer-implemented method of claim 13 wherein:
the method comprises the system storing an aptitude level of a student body of the course offering;
each learning activity has a minimum aptitude level;
the substitute learning activity has a minimum aptitude level not exceeding the aptitude level of the student body.

15. The computer-implemented method of claim 1 wherein obtaining progress information comprises the system receiving a skipped indication that a teacher is abandoning a learning activity.

16. The computer-implemented method of claim 15 wherein based on the progress information comprises based on the skipped indication.

17. The computer-implemented method of claim 15 wherein:
each learning activity may have a prerequisite academic standard; and
obtaining progress information comprises:
the system receiving multiple status data indicating a progress of each of multiple learning activities;
the system identifying and storing a completion subset of the multiple status data that indicate completion of each of multiple learning activities, not including learning activities having a skipped indication; and
if the status data indicates completion of a current learning activity:
the system selecting a next learning activity from the scheduled subset;
if the next learning activity has a prerequisite academic standard, and the academic standards of the completion subset do not include the prerequisite academic standard, the system selecting a review learning activity having a same academic standard as the prerequisite academic standard, and the system displaying the review learning activity.

18. The computer-implemented method of claim 1 wherein:
each learning activity of the scheduled subset has a start date; and
displaying a summary comprises:
the system displaying the learning activities of the scheduled subset on a line, and ordered by start date;
the system displaying on the line an indicator of a current learning activity and an indicator of a learning activity of the scheduled subset having a start date that matches a current date.

19. The computer-implemented method of claim 18 wherein displaying the learning activities comprises:
the system displaying a control associated with each learning activity of the scheduled subset; and
in response to a teacher selecting the control, the system displaying a detail of the associated learning activity.

20. The computer-implemented method of claim 1 wherein based on the progress information comprises based on a lapse of a periodic interval.
